(19) United States
(12) Patent Application Publication
(10) Pub. No.: US 2018/0018695 A1
(43) Pub. Date: Jan. 18, 2018

(54) COMPUTER IMPLEMENTED METHOD AND SYSTEM FOR DISTRIBUTION OF REVENUE ACCUMULATED IN A SEARCH NETWORK COMMUNITY POOL TO AN APPLICATION DEVELOPER

(71) Applicants: RASHMIT GUPTA, Hyderabad (IN); VISHAL GUPTA, Mumbai (IN)

(72) Inventors: RASHMIT GUPTA, Hyderabad (IN); VISHAL GUPTA, Mumbai (IN)

(21) Appl. No.: 15/548,419

(22) PCT Filed: Sep. 28, 2015
(86) PCT No.: PCT/IB2015/057417

§ 371 Date: Aug. 3, 2017

(30) Foreign Application Priority Data
Mar. 27, 2015 (IN) 1589/CHE/2015
Apr. 22, 2015 (IN) 2073/CHE/2015

(51) Int. Cl. G06Q 30/02; G06F 17/30

(52) U.S. Cl. CPC G06Q 30/0247; G06Q 30/0277; G06F 17/30864; G06Q 30/0251

(57) ABSTRACT

A computer implemented method and system for distribution of revenue accumulated in a search network community pool to application developer are disclosed. The method includes identifying a revenue generated in response to a type of an activity involved in generating the revenue in a search network and accumulating the revenue generated in a community pool of the search network, whereby the community pool comprising at least one stake holders, whereby the at least one stake holder comprising an application developer registered with the search network.

### TECHNICAL FIELD

The present disclosure relates to the field of revenue driven models in search networks. More particularly, the present disclosure relates to a computer implemented method and system for distribution of revenue accumulated in a search network community pool to an application developer.

### BACKGROUND

The statements in this section merely provide background information related to the present disclosure and may not constitute prior art.

Typically keywords are used in search engine to obtain the intended search results. Many of the search service providers have created paid inclusion or paid placement programs to obtain broader reach for more targeted advertising audiences. By identifying the keywords that the target audience is using to find information or products related to a business, a monetized search box is provided, that earn a fee or a commission for search service providers each time the user conducts a search.

For example, a user conducts search for “HOTELS IN BOMBAY”, in response the intended search results are displayed. For providing the targeted search results to the user the hotels in Bombay pay to search service providers to display their advertisements. In return the search service providers earn revenues by displaying the targeted search results. These advertising strategies implemented by the search service providers create huge revenue to the search service providers and the users are not benefited. Moreover, the search service providers fail to generate the revenue associated with the activities performed in the search network.

In the light of aforementioned discussion there exists need for a system and method that would ameliorate and overcome the abovementioned disadvantages.

### BRIEF SUMMARY

The following presents a simplified summary of the disclosure in order to provide a basic understanding to the reader. This summary is not an extensive overview of the disclosure and it does not identify key/critical elements of the disclosure or delineate the scope of the disclosure. Its sole purpose is to present some concepts disclosed herein in a simplified form as a prelude to the more detailed description that is presented later.

Exemplary embodiments of the present disclosure are directed towards a computer implemented method and system for distribution of revenue accumulated in a search network community pool to an application developer.

An exemplary objective of the present disclosure it to provide a search network for enabling the stake holders of the search network earn revenue in response to activities performed in the search network.

Another exemplary objective of the present disclosure is to convert activities performed in the search network to revenues.

According to an exemplary aspect, the method includes identifying a revenue generated in response to a type of an activity involved in generating the revenue in a search network.

According to an exemplary aspect, the method includes accumulating the revenue generated in a community pool of the search network, whereby the community pool comprising at least one stake holder, whereby the at least one stake holder comprising an application developer registered with the search network.

One or more of the above disclosed embodiments in addition to certain alternatives are provided in further detail below with reference to the attached figures. The disclosed subject matter is not, however, limited to any particular embodiment disclosed.

### BRIEF DESCRIPTION OF DRAWINGS

The drawings described herein are for illustration purposes only and are not intended to limit the scope of the present disclosure in anyway. Throughout the disclosure, like elements are represented by like reference numerals, which are given by way of illustration only and thus are not limitative of the various embodiments.

Other objects and advantages of the present disclosure will become apparent to those skilled in the art upon reading the following detailed description of the preferred embodiments, in conjunction with the accompanying drawings, wherein:

FIG. 1 is a diagram depicting a search network, according to an exemplary embodiment of the present disclosure.

FIG. 2 is a block diagram of a system for distribution of revenue accumulated in a search network community pool to an application developer, according to an exemplary embodiment of the present disclosure.

FIG. 3 is a diagram depicting the system of FIG. 1 and FIG. 2, according to an exemplary embodiment of the present disclosure.

FIG. 4 is a flow diagram depicting a method for distribution of revenue accumulated in a search network community pool to an application developer, according to an exemplary embodiment of the present disclosure.

### DETAILED DESCRIPTION OF EXEMPLARY EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item.

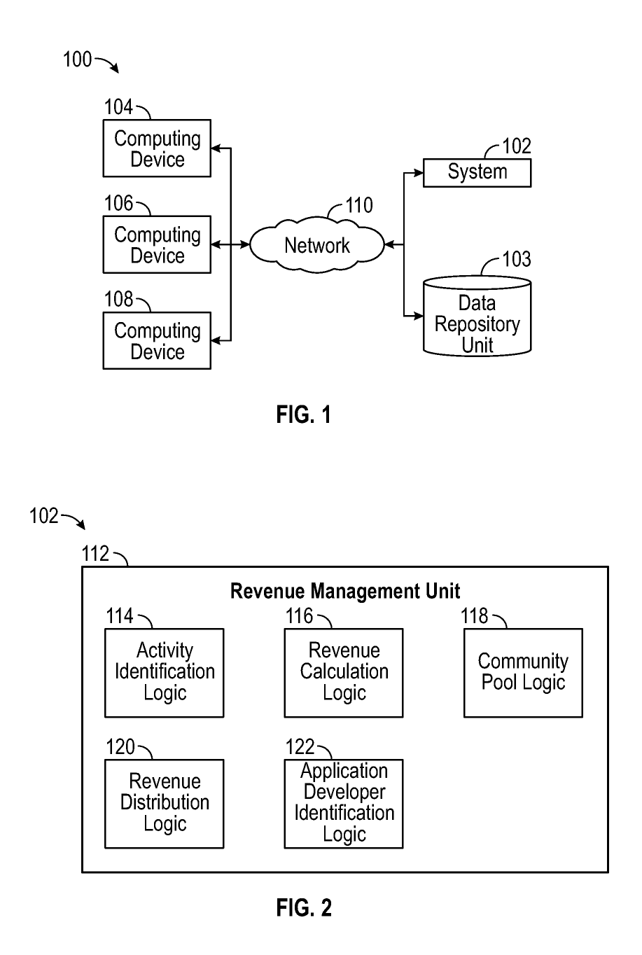

Referring to FIG. 1 is a diagram 100 depicting a search network, according to an exemplary embodiment of the present disclosure. The search network includes a system for distribution of revenue accumulated in a search network community pool to an application developer, herein after referred as system 102. The search network also manages revenue generated in data repository unit 103 connected to the system 102. The search network 100 is a network of computing devices 104, 106, 108 and system 102 in which the present invention may be implemented. The computing devices 104, 106 and 108 and system 102 are all connected over a network 110. The network 108 may include, but not limited to, an Ethernet, a local area network (LAN), or a wide area network (WAN), e.g., the Internet, or a combination of networks.

The system 102 allows the user to perform different types of activities in the search network. Furthermore the system 102 allows the user to input keyword(s) for retrieving the desired results. The different type of activities in the search network may include, but not limited to, conducting search in the search network, publishing advertisements in response to the user conducting search in the search network, trading of the keyword(s) and/or hashtags in the search network, and renewal of the of the keyword(s) and/or hashtags in the search network. Trading keyword(s) and/or hashtags in the search network may include, but not limited to, buying the keyword(s) and/or hashtags and selling the keyword(s) and/or hashtags. The type of activity performed in the search network resulting in the generation of revenue further includes the user conducting the search using a search based application of the application developer integrated with the search network. The user of the search network may be allowed to conduct a specific search in the search application developed by the developer. For example, the developer may develop an e-commerce application configured to perform buying and selling of products. The user of the search network is allowed to conduct a targeted search in the e-commerce application integrated with the search network for buying a desired product, in response to the user conducting search in the e-commerce application revenue is generated and the generated revenue is accumulated in the community pool before distributing to the application developer. The accumulated revenue may be further distributed among the other stake holders, including but not limited to, the user conducting the search in the search application using the keyword(s) and/or hashtags, an owner of the keyword(s) and/or hashtags used by the user in the search network, an owner of the search network. The keyword(s) here may include but not limited to any alphabet(s), word(s), special character(s), numeral(s), and alphanumeric character(s). The revenue generated may be distributed in the form of Bitcoin, loyalty points, rewards, digital currency, vouchers, reward points, coupons, and cash, without limiting the scope of the disclosure. For example ¼ of the revenue generated may be distributed to the application developer. Considering the revenue generated as 10000 satoshis, the application developer receives 2,500 satoshis. According to an exemplary embodiment of the present disclosure, the transactions associated with the distribution of the revenue may be recorded in a public distributed ledger called the block chain.

FIG. 2 is a block diagram 102 of a system for distribution of revenue accumulated in a search network community pool to an application developer, according to an exemplary embodiment of the present disclosure. The system 102 includes a revenue management unit 112 configured for managing the revenues generated in response to the activities performed in the search network. The revenue management unit 112 includes an activity identification logic 114, configured for identifying the type of activity performed in the search network for generating the revenue.

The revenue management unit 112 further includes a revenue calculation logic 116 for calculating total revenue generated in response to the activity performed in the search network and a community pool logic 118 for accumulating the revenue generated in the community pool.

The revenue management unit 112 further includes a revenue distribution logic 120 for distribution of the revenue accumulated in the community pool logic and application developer identification logic 122 for identification of the application developer eligible to receive the distributed revenue. The distributed revenue is credited to the account of the application developer.

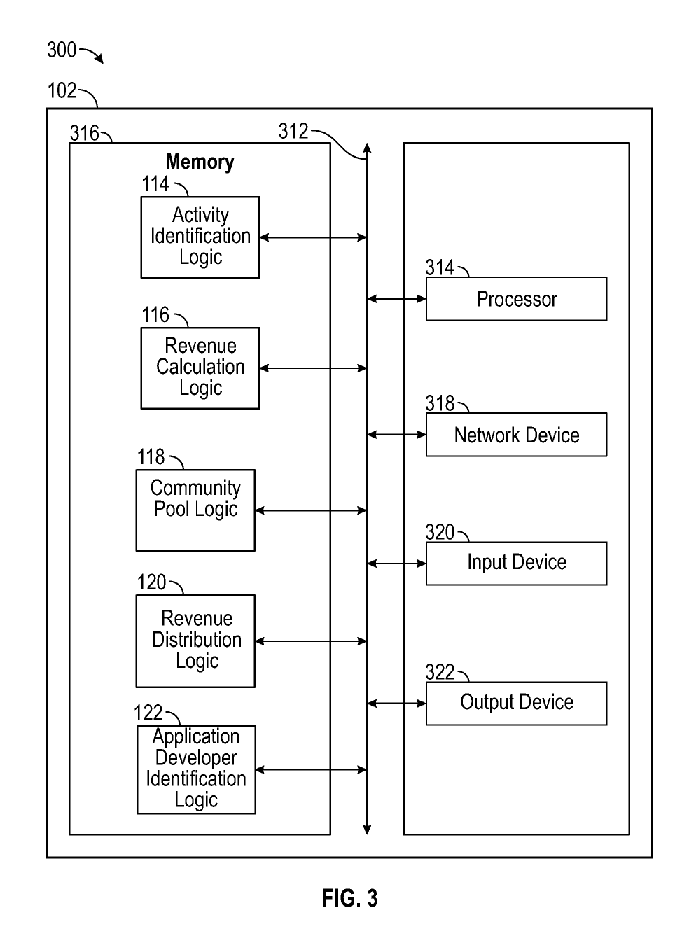

Referring to FIG. 3 is a diagram 300 depicting the system 102, according to an exemplary embodiment of the present disclosure. It should be noted, however, that embodiments are not limited to implementation on such computing devices, but may be implemented on any of a variety of different types of computing units within the scope of embodiments hereof. The system 102 is only one example of search and it is not intended to suggest any limitation as to the scope of use or functionality of the disclosure.

In some embodiments, the system 102 may include a bus 312, a processor 314, a memory 316, a network device 318, an input device 320, and an output device 322. The bus 312 may include a path that permits communication among the components of the system 102.

The memory 316 stores activity identification logic 114, revenue calculation logic 116, community pool logic 118, revenue distribution logic 120 and application developer identification logic 122 as software.

The memory 316 may be any type of computer memory known in the art or future-developed for electronically storing data and/or logic, including volatile and non-volatile memory. In this regard, memory 316 can include random access memory (RAM), read-only memory (ROM), flash memory, any magnetic computer storage unit, including hard disks, floppy discs, or magnetic tapes, and optical discs.

The processor 314 comprises processing hardware for interpreting or executing tasks or instructions stored in the memory 316. Note that the processor 314 may be a microprocessor, a digital processor, or other type of circuitry configured to run and/or execute instructions.

The network device 318 may be any type of network unit (e.g., a modem) known in the art or future-developed for communicating over a network 110 (FIG. 1).

The input device 320 is any type of input unit known in the art or future-developed for receiving data. As an example, the input unit 320 may be a keyboard, a mouse, a touch screen, a serial port, a scanner, a camera, or a microphone.

The output device 322 may be any type of output unit known in the art or future-developed for displaying or outputting data. As an example, the output device 322 may be a liquid crystal display (LCD) or other type of video display unit, a speaker, or a printer.

Further note that, the system 102 components may be implemented by software, hardware, firmware or any combination thereof. In the exemplary system 102, depicted by FIG. 1 and FIG. 2, all the components are implemented by software and stored in the memory 316.

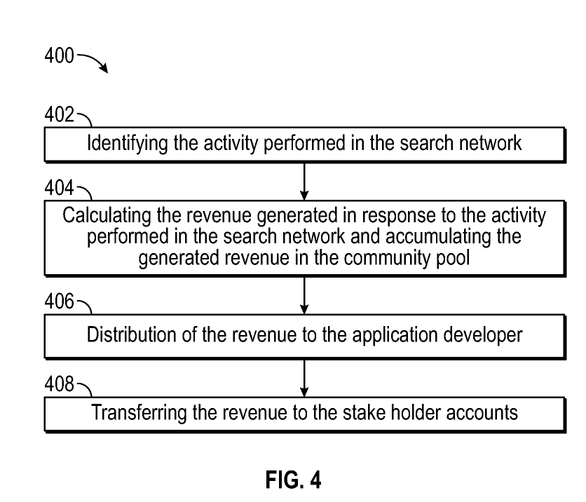

FIG. 4 is a flow diagram 400 depicting a method for distribution of revenue accumulated in a search network community pool to an application developer, according to an exemplary embodiment of the present disclosure. The method starts at step 402 by identifying the activity performed in the search network and continues to step 404 by calculating the revenue generated in response to the activity performed in the search network and accumulating the generated revenue in the community pool. The method continues to next step 406 by distribution of the revenue to the application developer and transferring the revenue to the stake holder accounts at step 408.

The claimed subject matter has been provided here with reference to one or more features or embodiments. Those skilled in the art will recognize and appreciate that, despite of the detailed nature of the exemplary embodiments provided here; changes and modifications may be applied to said embodiments without limiting or departing from the generally intended scope. These and various other adaptations and combinations of the embodiments provided here are within the scope of the disclosed subject matter as defined by the claims and their full set of equivalents.

1. A computer implemented method comprising:
identifying a revenue generated in response to a type of an activity involved in generating the revenue in a search network; and
accumulating the revenue generated in a community pool of the search network, whereby the community pool comprising at least one stake holder, whereby the at least one stake holder comprising an application developer registered with the search network.

2. The method of claim 1, wherein the type of activity involved in generating the revenue in the search network comprising:
publishing advertisements in response to a user conducting search in the search network;
trading of the at least one keyword in the search network; and
renewal of the at least one keyword in the search network.

3. The method of claim 1, wherein the type of activity involved in generating the revenue in the search network comprising the user conducting the search using a search based application of the application developer integrated with the search network.

4. A computer implemented method comprising:
identifying a revenue generated in response to a type of an activity involved in generating the revenue in a search network, wherein the type of activity comprising a user conducting a search in a search based application of the application developer integrated with the search network;
accumulating the revenue generated in a community pool of the search network; and
distributing the search network revenue generated to the application developer.

5. A system comprising:
a search network comprising revenue management unit for:
identifying a revenue generated in response to a type of an activity involved in generating the revenue in a search network, wherein the type of activity comprising a user conducting a search in a search based application of the application developer integrated with the search network;
accumulating the revenue generated in a community pool of the search network; and
distributing the search network revenue generated to the application developer.

6. The system of claim 5, wherein the revenue management unit further comprising an activity identification logic for identifying the type of activity involved in generating the revenue.

7. The system of claim 5, wherein the revenue management unit further comprising a revenue calculation logic for calculating total revenue generated in response to the activity performed in the search network.

8. The system of claim 5, wherein the revenue management unit further comprising a community pool logic for accumulating the revenue generated.

9. The system of claim 5, wherein the revenue management unit further comprising an application developer identification logic for distribution of the revenue accumulated in the community pool logic.

10. The system of claim 5, wherein the revenue management unit further comprising a revenue distribution logic for distribution of revenue accumulated in response to the type of activity involved.

11. The system of claim 5, wherein the distribution of the revenue generated recorded in a block chain.
